(19) United States
(12) Patent Application Publication
(10) Pub. No.: US 2024/0172332 A1
(43) Pub. Date: May 23, 2024

(54) ELECTRICALLY HEATING SUPPORT

(71) Applicants: NGK INSULATORS, LTD., Nagoya-Shi (JP); TOYOTA JIDOSHA KABUSHIKI KAISHA, Toyota-Shi (JP)

(72) Inventors: Yuta NAGATANI, Nagoya-Shi (JP); Shinobu SHIMASAKI, Toyota-Shi (JP)

(73) Assignees: NGK INSULATORS, LTD., Nagoya-Shi (JP); TOYOTA JIDOSHA KABUSHIKI KAISHA, Toyota-Shi (JP)

(21) Appl. No.: 18/502,150

(22) Filed: Nov. 6, 2023

(30) Foreign Application Priority Data
Nov. 22, 2022 (JP) 2022-186746

(51) Int. Cl. H05B 3/06; B01J 23/42; B01J 23/44; B01J 23/46; B01J 35/04

(52) U.S. Cl. CPC H05B 3/06; B01J 23/42; B01J 23/44; B01J 23/46; B01J 35/04

(57) ABSTRACT

An electrically heating support includes: a honeycomb structure 1 including a honeycomb structure portion 10 having an outer peripheral wall 100; and electrode layers 11 provided on a surface of the outer peripheral wall 100; metal electrodes 2; and a plurality of thermally sprayed fixed layers 3, wherein each of the pair of metal electrodes 2 includes: a base portion 20; and a comb tooth-shaped connection portion 21 having a plurality of teeth portions 23, wherein each of the tooth portions 23 includes at least one first portion 23a and at least one second portion 23b narrower than the first portion 23a, and wherein at least one of the thermally sprayed fixed layers 3 is provided on an outer peripheral surface of the honeycomb structure 1 and the at least one second portion 23b so that the connection portion 21 is fixed to the honeycomb structure 1.

### FIELD OF THE INVENTION

The present invention relates to an electrically heating support.

### BACKGROUND OF THE INVENTION

In general, electrically heating catalysts (EHCs) are known. The EHCs are for purifying an exhaust gas emitted when an internal combustion engine is in a cold state immediately after the internal combustion engine is started, by arranging electrodes on a honeycomb structure made of conductive ceramics, and heating the honeycomb structure itself by electrical conduction to increase a temperature of a catalyst supported on the honeycomb structure to its activation temperature before starting the engine. In order to heat the honeycomb structure by electrical conduction and efficiently purify the exhaust gas, it is necessary to heat the interior of the honeycomb structure while making the temperature distribution uniform. To achieve this, it is necessary to apply an electric current to the honeycomb structure as uniformly as possible, and firm connection of the honeycomb structure to the electrodes are required. Patent Literature 1 below discloses that electrode layers provided on a honeycomb structure and comb tooth portions of metal electrodes are joined by thermal spraying.

### CITATION LIST

### Patent Literature

[Patent Literature 1] Japanese Patent Application Publication No. 2012-106164 A

### SUMMARY OF THE INVENTION

When the comb tooth portion of each metal electrode is joined to each electrode layer of the honeycomb structure by thermal spraying as in Patent Literature 1, the joining strength decreases as the tooth width of the comb tooth portion increases. For this reason, it is desirable that the width of each tooth is narrower in terms of improving the impact resistance performance. On the other hand, it is desirable that the width of each tooth is wider in terms of increasing an amount of current that passes through the metal electrodes. That is, in the prior art, there is a trade-off relationship between the improvement in shock resistance performance and the increase in conducted current, and there is still room for improvement in achieving the both.

The present invention has been made to solve the above problems. One of objects of the present invention is to provide an electrically heating support that can increase an amount of current passing through the metal electrodes while maintaining joining strength between the honeycomb structure and the metal electrodes.

### Aspect 1.

In an embodiment, the present invention relates to an electrically heating support, wherein the electrically heating support comprises: a honeycomb structure comprising: a honeycomb structure portion having an outer peripheral wall and a partition wall arranged on an inner side of the outer peripheral wall, the partition wall defining a plurality of cells each extending from one end face to other end face to form a flow path; and a pair of electrode layers provided on a surface of the outer peripheral wall; a pair of metal electrodes for applying voltage to the honeycomb structure; and a plurality of thermally sprayed fixed layers for fixing the pair of metal electrodes to the honeycomb structure, wherein each of the pair of metal electrodes comprises: a base portion; and a comb tooth-shaped connection portion having a plurality of teeth portions each extending from the base portion, wherein each of the tooth portions comprises at least one first portion and at least one second portion narrower than the first portion, and wherein at least one of the thermally sprayed fixed layers is provided on an outer peripheral surface of the honeycomb structure and the at least one second portion so as to be across the at least one second portion in a width direction of the tooth portions so that the connection portion is fixed to the honeycomb structure.

### Aspect 2.

The present invention may also relate to the electrically heating support according to Aspect 1, wherein the at least one first portion extends from the base portion and the at least one second portion extends from a tip of the at least one first portion.

### Aspect 3.

The present invention may also relate to the electrically heating support according to Aspect 1 or 2, wherein the plurality of tooth portions comprise: first tooth portions fixed to the honeycomb structure at first positions; and second tooth portions fixed to the honeycomb structure at second positions which are different from the first positions in an extending direction of the tooth portions from the base portion.

### Aspect 4.

The present invention may also relate to the electrically heating support according to Aspect 3, wherein the first and second teeth portions are alternately arranged in an extending direction of the base portion.

### Aspect 5.

The present invention may also relate to the electrically heating support according to Aspect 3 or 4, wherein each of the tooth portions comprises a plurality of second portions, and each of the thermally sprayed fixed layers is provided so as to be across a part of the plurality of second portions, and wherein the thermally sprayed fixed layer on one of the first and second tooth portions is formed to be inserted into at least one groove formed by the other of the first and second portions on the first and second teeth portions.

### Aspect 6.

The present invention may also relate to the electrically heating support according to any one of Aspects 1 to 5, wherein each of the tooth portions comprises a plurality of second portions, and each of the thermally sprayed fixed layers is provided so as to be across at least one of the second portions.

### Aspect 7.

The present invention may also relate to the electrically heating support according to any one of Aspects 1 to 6, wherein a ratio (A2/A1) of an area (A2) of each of the second portions covered with each of the thermally sprayed fixed layers to an area (A1) of each of the thermally sprayed fixed layers as viewed along a thickness direction of the thermally sprayed fixed layer and the second portion is more than or equal to 0.1 and less than or equal to 0.5.

### Aspect 8.

The present invention may also relate to the electrically heating support according to any one of Aspects 1 to 7, wherein the connection portion has a thickness of less than or equal to 0.05 mm and less than or equal to 0.7 mm.

### Aspect 9.

The present invention may also relate to the electrically heating support according to any one of Aspects 1 to 8, wherein each of the pair of metal electrodes comprises a plurality of electrode bodies each having the connection portion.

### Aspect 10.

The present invention may also relate to the electrically heating support according to any one of Aspects 1 to 9, wherein a central position of each of the thermally sprayed fixed layers in the extending direction of the tooth portion from the base portion is located at the same position as a central portion of each of the second portions in the extending direction, or located at a position closer to the base portion than the central portion of each of the second portions in the extending direction.

### Aspect 11.

The present invention may also relate to the electrically heating support according to any one of Aspects 1 to 10, wherein each of the thermally sprayed fixed layers is arranged adjacent to the at least one first portion.

### Aspect 12.

The present invention may also relate to the electrically heating support according to any one of Aspects 1 to 11, wherein a ratio (W2/W1) of a width (W2) of the at least one second portion to a width (W1) of the at least one first portion is more than or equal to 0.3 and less than or equal to 0.8 or less.

According to one embodiment of an electrically heating support, an amount of current passing through the metal electrodes can be increased while maintaining joining strength between the honeycomb structure and the metal electrodes.

### BRIEF DESCRIPTION OF THE DRAWINGS

FIG. 1 is a perspective view showing a honeycomb structure of an electrically heating support according to Embodiment 1 of the present invention;

FIG. 2 is a perspective view showing a metal electrode fixed to the honeycomb structure of FIG. 1;

FIG. 3 is a plane view showing the metal electrode and thermally sprayed fixed layers of FIG. 2;

FIG. 4 is a plane view showing a metal electrode and thermally sprayed fixed layers of an electrically heating support according to Embodiment 2 of the present invention;

FIG. 5 is a plane view showing a metal electrode and thermally sprayed fixed layers of an electrically heating support according to Embodiment 3 of the present invention; and

FIG. 6 is a perspective view of an electrically heating support according to Embodiment 4 of the present invention.

### DETAILED DESCRIPTION OF THE INVENTION

Hereinafter, embodiments for carrying out the present invention will be described with reference to the drawings. The present invention is not limited to each embodiment, and components can be modified and embodied without departing from the spirit of the present invention. Further, various inventions can be formed by appropriately combining a plurality of components disclosed in each embodiment. For example, some components may be removed from all of the components shown in the embodiments. Furthermore, the components of different embodiments may be optionally combined.

### Embodiment 1

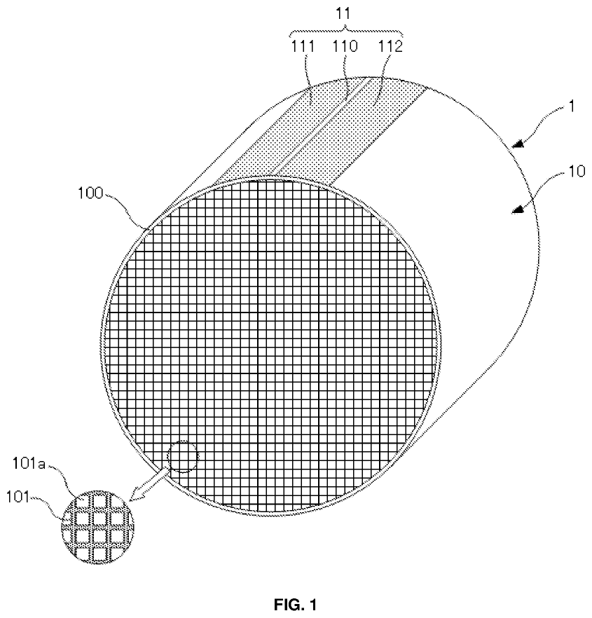

FIG. 1 is a perspective view showing a honeycomb structure 1 of an electrically heating support according to Embodiment 1 of the present invention. The honeycomb structure 1 shown in FIG. 1 forms a part of the electrically heating support. The electrically heating support can increase a temperature of a catalyst supported on the honeycomb structure 1 to its activation temperature before starting an engine by generating heat in the honeycomb structure 1 by electrical conduction. The electrically heating support is provided, for example, on an exhaust path of an automobile or the like, and can be used to purify an exhaust gas discharged from the engine.

The honeycomb structure 1 includes a honeycomb structure portion 10 and a pair of electrode layers 11.

The honeycomb structure portion 10 is a pillar shaped member made of ceramics, and includes: an outer peripheral wall 100; and a partition wall 101 which is arranged on an inner side of the outer peripheral wall 100 and defines a plurality of cells 101a each extending from one end face to other end face to form a flow path. The pillar shape is understandable as a three-dimensional shape having a thickness in a flow path direction of the cells 101a (an axial direction of the honeycomb structure portion 10). A ratio of an axial length of the honeycomb structure portion 10 to a diameter or width of the end face of the honeycomb structure portion 10 (aspect ratio) is arbitrary. The pillar shape may also include a shape in which the axial length of the honeycomb structure portion 10 is shorter than the diameter or width of the end face (flat shape).

An outer shape of the honeycomb structure portion 10 is not particularly limited as long as it has a pillar shape. For example, it can be other shapes such as a pillar shape having circular end faces (cylindrical shape), a pillar shape having oval end faces, and a pillar shape having polygonal (rectangular, pentagonal, hexagonal, heptagonal, octagonal, etc.) end faces. As for the size of the honeycomb structure portion 10, an area of the end faces is preferably from 2,000 to 20,000 mm², and even more preferably from 5,000 to 15,000 mm², in order to increase heat resistance (to suppress cracks generated in the circumferential direction of the outer peripheral wall).

A shape of each cell in the cross section perpendicular to the flow path direction of the cells 101a may preferably be a quadrangle, hexagon, octagon, or a combination thereof, although not limited thereto. Among these, the quadrangle and the hexagon are preferred. Such a cell shape can lead to a decreased pressure loss when an exhaust gas flows through the honeycomb structure portion 10, which can provide improved purification performance.

The partition wall 101 that defines the cells 101a preferably has a thickness of from 0.1 to 0.3 mm, and more preferably from 0.1 to 0.2 mm. The thickness of 0.1 mm or more of the partition wall 101 can suppress a decrease in the strength of the honeycomb structure portion 10. The thickness of the partition wall 101 of 0.3 mm or less can suppress a larger pressure loss when an exhaust gas flows through the honeycomb structure portion 10 if the honeycomb structure portion 10 is used as a catalyst support to support a catalyst. In the present invention, the thickness of the partition wall 101 is defined as a length of a portion passing through the partition wall 101, among line segments connecting the centers of gravity of adjacent cells 101a, in the cross section perpendicular to the flow path direction of the cells 101a.

The honeycomb structure portion 10 preferably has a cell density of from 40 to 150 cells/cm², and more preferably from 70 to 100 cells/cm², in the cross section perpendicular to the flow path direction of the cells 101a. The cell density in such a range can allow the purification performance of the catalyst to be increased while reducing the pressure loss when the exhaust gas flows. The cell density of 40 cells/cm² or more can allow a catalyst supported area to be sufficiently ensured. The cell density of 150 cells/cm² or less can prevent the pressure loss when the exhaust gas flows through the honeycomb structure portion 10 from being increased if the honeycomb structure portion 10 is used as a catalyst support to support the catalyst. The cell density is a value obtained by dividing the number of cells by the area of one end face portion of the honeycomb structure portion 10 excluding the outer peripheral wall 100 portion.

The provision of the outer peripheral wall 100 of the honeycomb structure portion 10 is useful from the viewpoints of ensuring the structural strength of the honeycomb structure portion 10 and suppressing the leakage of a fluid flowing through the cells 101a from the outer peripheral wall 100. Specifically, the thickness of the outer peripheral wall 100 is preferably 0.05 mm or more, and more preferably 0.10 mm or more, and even more preferably 0.15 mm or more. However, if the outer peripheral wall 100 is too thick, the strength will be too high, and a strength balance between the outer peripheral wall 100 and the partition wall 101 will be lost, resulting in a decrease in thermal shock resistance. Therefore, the thickness of the outer peripheral wall 100 is preferably 1.0 mm or less, and more preferably 0.7 mm or less, and even more preferably 0.5 mm or less. The thickness of the outer peripheral wall 100 is defined as a thickness of the outer peripheral wall 100 in the normal line direction relative to the tangent line at a measured point when the point of the outer peripheral wall 100 where the thickness is to be measured is observed in the cross section perpendicular to the flow path direction of the cells 101a.

The honeycomb structure portion 10 is made of ceramics and is preferably electrically conductive. Volume resistivity is not particularly limited as long as the honeycomb structure portion 10 is capable of heat generation by Joule heat when a current is applied. Preferably, the volume resistivity is from 0.1 to 200 Ωcm, and more preferably from 1 to 200 Ωcm. As used herein, the volume resistivity of the honeycomb structure portion 10 refers to a value measured at 25° C. by the four-terminal method.

The honeycomb structure portion 10 can be made of a material selected from the group consisting of oxide ceramics such as alumina, mullite, zirconia and cordierite, and non-oxide ceramics such as silicon carbide, silicon nitride and aluminum nitride, although not limited thereto. Further, silicon carbide-silicon composite materials and silicon carbide/graphite composite materials can also be used. Among these, it is preferable that the material of the honeycomb structure portion 10 contains ceramics mainly based on a silicon-silicon carbide composite material or silicon carbide, in terms of balancing heat resistance and electrical conductivity. The phrase “the material of the honeycomb structure portion 10 is mainly based on silicon-silicon carbide composite material” means that the honeycomb structure portion 10 contains 90% by mass of more of silicon-silicon carbide composite material (total mass) based on the total material. Here, the silicon-silicon carbide composite material contains silicon carbide particles as an aggregate and silicon as a binding material to bind the silicon carbide particles, preferably in which a plurality of silicon carbide particles are bound by silicon such that pores are formed between the silicon carbide particles. The phrase “the material of the honeycomb structure portion 10 is mainly based on silicon carbide” means that the honeycomb structure portion 10 contains 90% or more of silicon carbide (total mass) based on the total material.

When the honeycomb structure portion 10 contains the silicon-silicon carbide composite material, a ratio of the “mass of silicon as a binding material” contained in the honeycomb structure portion 10 to the total of the “mass of silicon carbide particles as an aggregate” contained in the honeycomb structure portion 10 and the “mass of silicon as a binding material” contained in the honeycomb structure portion 10 is preferably from 10 to 40% by mass, and more preferably from 15 to 35% by mass.

The outer peripheral wall 100 and partition wall 101 may be porous. When they are porous, the porosity of each of the outer peripheral wall 100 and the partition wall 101 is preferably from 35 to 60%, and even more preferably from 35 to 45%. The porosity is a value measured by a mercury porosimeter. Further, the outer peripheral wall 100 and the partition wall 101 may be dense, and when they are dense, the porosity of each of the outer peripheral wall 100 and the partition wall 101 may be 10% or less, or 5% or less.

Each of the outer peripheral wall 100 and the partition wall 101 of the honeycomb structure portion 10 preferably has an average pore diameter of from 2 to 15 μm, and even more preferably from 4 to 8 μm. The average pore diameter is a value measured by a mercury porosimeter.

The pair of electrode layers 11 are provided on the surface of the outer peripheral wall 100. Each of the electrode layers 11 forms the outer peripheral surface of the honeycomb structure 1 together with the outer peripheral wall 100. The electrode layers 11 according to this embodiment are provided to be spaced apart from each other in the circumferential direction of the honeycomb structure portion 10. More particularly, the electrode layers 11 are provided across the central axis of the honeycomb structure 10. In FIG. 1, only one of the pair of electrode layers 11 is shown.

Each of the pair of electrode layers 11 according to this embodiment has: a separator 110; and first and second partial electrode layers 111, 112 separated by the separator 110. The separator 110 may be a slit provided between the first and second partial electrode layers 111,112. The slit may be filled with a material having a higher volume resistivity than that of each of the first and second partial electrode layers 111, 112. The separator 110 and the first and second partial electrode layers 111, 112 extend from one end to the other end of the honeycomb structure 10 in the flow path direction of the cells 101a. Each of the first and second partial electrode layers 111, 112 has a strip shape having a predetermined width in the circumferential direction of the honeycomb structure portion 10, and the separator 110 has a linear shape having a width narrower than that of each of the first and second partial electrode layers 111, 112. However, the method of arranging the separator 110 and the first and second partial electrode layers 111, 112 is not limited to this form as long as it can be connected to a pair of metal electrodes 2 as described below.

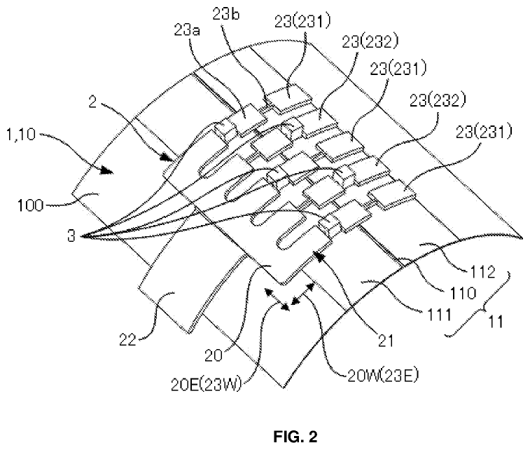

As will be described later, in the electrically heating support according to the present embodiment, metal electrodes 2 (see FIG. 2) are fixed on the electrode layers 11. Although not shown, the metal electrodes 2 can be connected to an external power source such as a battery via a power cable. By applying a voltage to the honeycomb structure 10 through the metal electrodes 2 and the electrode layers 11, the honeycomb structure 10 can generate heat.

The volume resistivity of the electrode layers 11 is preferably 1/200 or more and 1/10 or less of that of the honeycomb structure portion 10, in terms of facilitating the flow of electricity to the electrode layers 11.

Each electrode layer 11 may be made of conductive ceramics, a metal, or a composite material (cermet) of a metal and a conductive ceramic. Examples of the metal include a single metal of Cr, Fe, Co, Ni, Si or Ti, or an alloy containing at least one metal selected from the group consisting of those metals. Non-limiting examples of the conductive ceramics include silicon carbide (SiC), and metal compounds such as metal silicides such as tantalum silicide (TaSi₂) and chromium silicide (CrSi₂).

As a method for producing the honeycomb structure 1 having the electrode layers 11, first, an electrode layer forming raw material containing ceramic raw materials is applied onto a side surface of a honeycomb dried body and dried to form a pair of unfired electrode layers on the outer surface of the outer peripheral wall so as to extend in the form of band in the flow path direction of the cells, across the central axis of the honeycomb dried body, thereby providing a honeycomb dried body with unfired electrode layers. Then, the honeycomb dried body with unfired electrode layers is fired to produce a honeycomb fired body having a pair of electrode layers. The honeycomb structure 1 having the electrode layers 11 is thus obtained.

By supporting a catalyst on the honeycomb structure portion 10, the electrically heating support can be used as a catalyst body. Examples of the catalyst include noble metal-based catalysts and catalysts other than those. Illustrative examples of the noble metal catalysts include three-way catalysts and oxidation catalysts having a noble metal such as platinum (Pt), palladium (Pd), and rhodium (Rh) supported on surfaces of alumina pores, and containing a co-catalyst such as ceria and zirconia; or lean NOx trap catalysts (LNT catalysts) containing an alkaline earth metal and platinum as storage components for nitrogen oxides (NOx). Examples of catalysts that do not use noble metals include NOx catalytic reduction catalysts (SCR catalysts) containing copper-substituted or iron-substituted zeolites, and the like. Further, two or more types of catalysts selected from those catalysts may be used. A method of supporting the catalyst is also not particularly limited, and it can be carried out according to the conventional method of supporting the catalyst on the honeycomb structure.

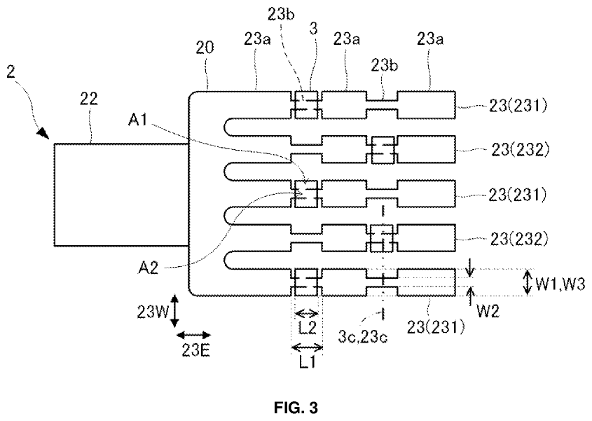

Next, FIG. 2 is a perspective view showing the metal electrode 2 fixed to the honeycomb structure 1 of FIG. 1, and FIG. 3 is a plane view showing the metal electrode 2 and the thermally sprayed fixed layers 3 of FIG. 2. The electrically heating support according to the present embodiment includes the honeycomb structure 1 as described above, a pair of metal electrodes 2 for applying a voltage to the honeycomb structure 1, and a plurality of thermally sprayed fixed layers 3 for fixing the pair of metal electrodes 2 to the honeycomb structure 1. FIG. 2 shows a main part of the electrically heating support according to an embodiment of the present invention, illustrating a state where one metal electrode 2 is fixed to one electrode layer 11. The other metal electrode 2 is fixed in the same manner to the other electrode layer 11. One of the pair of metal electrodes 2 is used as a positive electrode and the other is used as a negative electrode. That is, the current flows from one metal electrode 2 through the honeycomb structure 1 to the other metal electrode 2.

Each of the pair of metal electrodes 2 is provided with a base portion 20, a connection portion 21 and a drawer portion 22. The base portion 20, the connection portion 21, and the drawer portion 22 can be formed of plates. At least the base portion 20 and the connection portion 21 are arcuate so as to be along the outer peripheral surface of the honeycomb structure 1 or can be arcuate. Larger thicknesses of the base portion 20, the connection portion 21, and the drawer portion 22 are more advantageous for increasing allowable current. On the other hand, an excessively large thickness of the connection portion 21 results in an increased rigidity of the connection portion 21, so that the connection portion 21 tends to spring back after the thermally sprayed fixed layer 3 is formed. The spring-back of the connection portion 21 becomes a load on the thermally sprayed fixed layer 3. For this reason, the thickness of the connection portion 21 is preferably more than or equal to 0.05 mm and less than or equal to 0.7 mm. The thickness of 0.05 mm or more ensures sufficient strength and allowable current of the connection portion 21. The thickness of 0.7 mm or less can reduce a risk that the thermally sprayed fixed layer 3 will be damaged due to the spring-back of the connection portion 21. The thickness of the connection portion 21 is more preferably more than or equal to 0.1 mm and less than or equal to 0.3 mm, and still more preferably more than or equal to 0.1 mm and less than or equal to 0.2 mm. Each of the base portion 20 and the drawer portion 22 may have the same thickness as that of the connection portion 21. However, the thickness of each of the base portion 20 and the drawer portion 22 may be different from that of the connection portion 21.

The base portion 20 is provided integrally with the connection portion 21 and the drawer portion 22. The base portion 20 is arranged between the connection portion 21 and the drawer portion 22. The base 20 can be an elongated plate. Each of the metal electrodes 2 can be arranged on the outer peripheral surface of the honeycomb structure 1 such that an extending direction 20E (longitudinal direction) of the base portion 20 is along the flow path direction of the cells 101a. In this case, a width direction 20W of the base portion 20 orthogonal to the extending direction 20E can extend in the circumferential direction of the honeycomb structure 1. Each of the metal electrodes 2 may be arranged on the outer peripheral surface of the honeycomb structure 1 such that the base portion 20 is positioned on an outer side of the electrode layer 11 (an outer side of one of the first and second partial electrode layers 111, 112) in the circumferential direction of the honeycomb structure 1.

The connection portion 21 is a portion that is fixed to the honeycomb structure 1 and electrically connected to the honeycomb structure 1. The connection portion 21 according to the present embodiment is connected to the electrode layer 11 of the honeycomb structure 1. More specifically, the connection portion 21 is connected to the first and second partial electrode layers 111, 112.

The connection portion 21 according to the present embodiment has a comb shape having a plurality of teeth portions 23 each extending from the base portion 20. The tooth portions 23 are spaced apart from each other in an extending direction 20E of the base portion 20 and extends from one end of the base portion 20 in a width direction 20W. The extending direction 23E of each tooth portion 23 from the base portion 20 may be the same as the width direction 20W of the base portion 20. The length of each tooth portion 23 extending from the base portion 20 can be equal to or greater than the extending width of the electrode layer 11 in the circumferential direction of the honeycomb structure 1.

The drawer portion 22 is a portion drawn out from the base portion 20. The drawer portion 22 extends from the other end of the base portion 20 in the width direction 20W. The drawer portion 22 may be tongue-shaped as shown in the drawing. The drawer portion 22 is fixed to the honeycomb structure 1 via the base portion 20 and the connection portion 21, and the drawer portion 22 itself may be provided so as to be bendable. An external power source can be connected to the drawer portion 22 via a power cable (not shown).

As described above, the thermally sprayed fixed layers 3 fix the metal electrodes 2 to the honeycomb structure 1. Each of the thermally sprayed fixed layers 3 can be formed by blowing the thermally sprayed material against the outer peripheral surface of the honeycomb structure 1 (the electrode layer 11) and against each tooth portion 23 while placing the connection portion 21 on the outer peripheral surface of the honeycomb structure 1. Each thermally sprayed fixed layer 3 is provided on the outer peripheral surface of the honeycomb structure 1 (the electrode layer 11) and on the teeth portion 23 so as to be across each teeth portion 23 in the width direction 23W of the teeth portion 23. The width direction 23W of the tooth portion 23 is a direction orthogonal to an extending direction 23E of the tooth portion 23, which may be the same direction as the extending direction 20E of the base portion 20.

On the upper surface of each electrode layer 11, that is, between each electrode layer 11 and each metal electrode 2 may be a thermally sprayed underlayer to improve adhesion of each thermally sprayed fixed layer 3. When the thermally sprayed underlayer is provided on the upper surface of each electrode layer 11, the thermally sprayed underlayer can form the outer peripheral surface of the honeycomb structure 1. Even if the thermally sprayed underlayer is provided, the metal electrode 2 is also fixed to the honeycomb structure 1.

The thermally sprayed fixed layers 3 and the thermally sprayed underlayers can be made of conductive ceramics. The conductive ceramics forming the thermally sprayed underlayers include, but not limited to, silicon carbide (SIC), and metal compounds such as metal silicides such as tantalum silicide (TaSi₂) and chromium silicide (CrSi₂), and further composite materials (cermet) containing one or more metals. Specific examples of the cermet include composite materials of metal silicon and silicon carbide, composite materials of a metal silicide such as tantalum silicide and chromium silicide, metal silicon and silicon carbide, and composite materials obtained by adding to one or more metals as described above one or more insulating ceramics such as alumina, mullite, zirconia, cordierite, silicon nitride, bentonite and aluminum nitride, in terms of reducing thermal expansion. The metals that can be used herein, other than the above metals, include heat-resistant metals such as metals containing Al or Cr, SUS, or Ni—Cr alloys, and the like.

Each tooth portion 23 of each metal electrode 2 according to the present embodiment includes a plurality of first portions 23a (wider portions) and a plurality of second portions 23b (narrower portions) which are narrower than the first portions 23a. Each thermally sprayed fixed layer 3 is provided on the outer peripheral surface of the honeycomb structure 1 and the second portion 23b so as to be across each second portion 23b in a width direction of the second portion 23b (i.e., a width direction 23W of each tooth portion 23), thereby fixing the connection portion 21 to the honeycomb structure 1.

The present inventor presumes that such a structure provides effects as described below. In the case where the thermally sprayed fixed layer 3 is provided so as to be across the second portion 23b, the contact area of the outer peripheral surface of the honeycomb structure 1 with the thermally sprayed fixed layer 3 can be widened as compared with a case where the thermally sprayed fixed layer 3 having the same size is provided on the first portion 23a. Therefore, the provision of the thermally sprayed fixed layer 3 so as to be across the second portion 23b can improve the joining strength of each tooth portion 23 to the honeycomb structure 1. On the other hand, each tooth portion 23 has the first portions 23a, so that the amount of current that can flow through the metal electrodes 2 can be increased as compared with a case where the entire tooth portion 23 is formed by the narrower second portion 23b. More particularly, each tooth portion 23 has the first portions 23a, so that the heat generated in the second portions 23b by electrical conduction can be transferred to the first portions 23a, resulting in improvement of the upper limit of the current of the electrical conduction due to overheating of the second portions 23b. Therefore, in the electrically heating support according to the present embodiment, the amount of the current passing through the metal electrodes 2 can be increased while maintaining the joining strength between the honeycomb structure 1 and each metal electrode 2.

Preferably, each wider first portion 23a extends from the base portion 20 and each narrower second portion 23b extends from the tip of the first portion 23a. The extending of the first portion 23a from the base portion 20 can ensure a more reliable increase in the amount of the current flowing through the metal electrodes 2 than the case where the second portion 23b extends from the base portion 20. In this embodiment, all the teeth portions 23 have the first portions 23a each extending from the base portion 20. However, at least one tooth portion 23 may have the second portion 23b extending from the base portion 20. Also, as illustrated, the other first portion 23a may extend from the tip of the second portion 23b, and the other second portion 23b may extend from the tip of that other first portion 23a. The number of the first and second portions 23a, 23b is arbitrary.

The tooth portions 23 preferably include first tooth portions 231 fixed to the honeycomb structure 1 at first positions and second tooth portions 232 fixed to the honeycomb structure 1 at second positions different from the first positions in an extending direction 23E of the tooth portions 23 from the base portion 20. In this embodiment, each first tooth portion 231 is fixed to the first partial electrode layer 111 and the second tooth portion 232 is fixed to the second partial electrode layer 112. The tooth portions 23 have the first and second tooth portions 231, 232, so that the amount of the current flowing through the honeycomb structure 1 can be made more uniform than the case where the tooth portions 23 are fixed at only one position.

It is preferable that the first and second tooth portions 231, 232 are alternately arranged in an extending direction 20E of the base portion 20. In this embodiment, the first tooth portion 231 and the second tooth portion 232 are alternately arranged in this order from the front side in the drawing. By alternately arranging the first and second tooth portions 231, 232, the current flowing through the honeycomb structure 1 can be made more uniform than the case where the first and second tooth portions 231, 232 are arranged in an uneven manner.

A plurality of second portions 23b may be provided on each tooth portion 23 as in the present embodiment, and each thermally sprayed fixed layer 3 may be provided so as to be across at least one of the plurality of second portions 23b. In this embodiment, each thermally sprayed fixed layer 3 is provided so as to be across one of the second portions 23b. However, the thermally sprayed fixed layer 3 may be provided so as to be across all of the second portions 23b. That is, one tooth portion 23 may be fixed to the honeycomb structure 1 at a plurality of positions by a plurality of thermally sprayed fixed layers 3.

A ratio of an area (A2) of each second portion 23b covered with the thermally sprayed fixed layer 3 to an area (A1) of each thermally sprayed fixed layer 3 as viewed along the thickness direction of the thermally sprayed fixed layer 3 and the second portion 23b (A2/A1) is preferably more than or equal to 0.1 and less than or equal to 0.5. The ratio (A2/A1) of 0.1 or more can ensure a sufficient allowable current per unit length in the axial direction of the honeycomb structure 1. The ratio (A2/A1) of 0.5 or less can ensure sufficient joining strength of the thermally sprayed fixed layers 3 to the honeycomb structure 1. The ratio (A2/A1) is more preferably more than or equal to 0.2 and less than or equal to 0.4. The thickness direction of the thermally sprayed fixed layer 3 and the second portion 23b may be a direction along a normal line of the honeycomb structure 1 at positions of the thermally sprayed fixed layer 3 and the second portion 23b. The area (A1) of the thermally sprayed fixed layer 3 is larger than the area (A2) of the second portion 23b covered with the thermally sprayed fixed layer 3. The area (A2) of the second portion 23b covered with the thermally sprayed fixed layer 3 does not include an area of an exposed portion which is not covered with the thermally sprayed fixed layer 3 of the second portion 23b. The area (A1) of the thermally sprayed fixed layer 3 and the area (A2) of the second portion 23b covered with the thermally sprayed fixed layer 3 may be determined for each thermally sprayed fixed layer 3.

A ratio (L2/L1) of a length (L2) of each thermally sprayed fixed layer 3 in the extending direction 23E to a length (L1) of the second portion 23b in the extending direction 23E of the tooth portion 23 from the base portion 20 is preferably more than or equal to 0.7. The ratio (L2/L1) of 0.7 or more can suppress an increase in a temperature of the exposed portion of each second portion 23b which is not covered with the thermally sprayed fixed layer 3. More preferably, the ratio (L2/L1) is more than or equal to 0.8. The length (L2) of the thermally sprayed fixed layer 3 may be determined for each thermally sprayed fixed layer 3. The length (L1) of the second portion 23b is the total length of the second portion 23b covered with the thermally sprayed fixed layer 3. That is, the length (L1) of the second portion 23b also includes the length of the exposed portion of the second portion 23b that is not covered with the thermally sprayed fixed layer 3. In this embodiment, the length (L2) of the thermally sprayed fixed layer 3 is shorter than the length (L1) of the second portion 23b, that is, the ratio (L2/L1) is 1.0 or less, the exposed portions which are not covered with the thermally sprayed fixed layer 3 are provided on both sides of the thermally sprayed fixing layer 3. However, the length (L2) of at least one thermally sprayed fixed layer 3 may be larger than or equal to the length (L1) of the second portion 23b. Also, at least one thermally sprayed fixed layer 3 may be overlaid on the first portion 23a.

A central position 3c (see FIG. 3) of the thermally sprayed fixed layer 3 in the extending direction 23E of the teeth portion 23 from the base portion 20 is preferably located at the same position as a central position 23c (see FIG. 3) of the second portion 23b in the extending direction 23E or at a position closer to the base portion 20 than the central position 23c of the second portion 23b in the extending direction 23E. In other words, the thermally sprayed fixed layer 3 is preferably provided so as to cover a portion of the second portion 23b that is closer to the base portion 20. The central position 3c (see FIG. 3) of the thermally sprayed fixed layer 3 is located at the same position as the central position 23c of the second portion 23b or at the position closer to the base portion 20 than the central position 23c, so that the amount of current limited by the second portion 23 b can be made more restrictive. In this embodiment, the central positions 3c of all the thermally sprayed fixed layers 3 are the same as the central positions 23c (see FIG. 3) of the respective second portions 23b. The central positions 3c of some of the thermally sprayed fixed layers 3 may be shifted from the central positions 23c of the second portions 23b.

A ratio (W2/W1) of a width (W2) of each second portion 23b to a width (W1) of each first portion 23a is preferably more than or equal to 0.3 and less than or equal to 0.8. The ratio (W2/W1) of 0.3 or more can ensure sufficient strength at a boundary between the first portion 23a and the second portion 23b. Moreover, the ratio (W2/W1) of 0.8 or less can allow the heat generated in the second portions 23b to be sufficiently released to the first portions 23a. The ratio (W2/W1) is more preferably more than or equal to 0.4 and less than or equal to 0.7. The ratio (W2/W1) may be determined for each tooth portion 23. When each tooth portion 23 has a plurality of first and second portions 23a, 23b, the ratio (W2/W1) may be determined for each pair of first and second portions 23a, 23b adjacent to each other.

### Embodiment 2

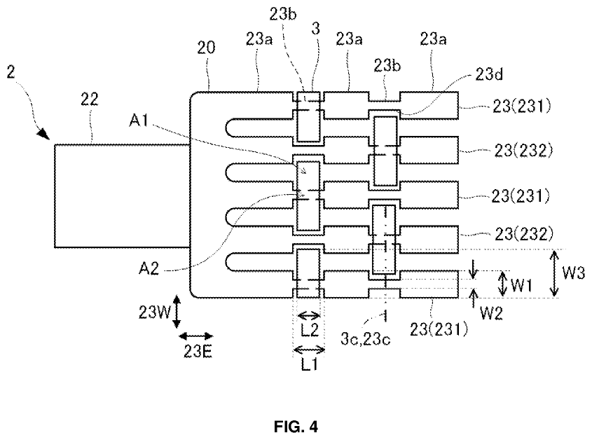

FIG. 4 is a plane view showing a metal electrode 2 and thermally sprayed fixed layers 3 of an electrically heating support according to Embodiment 2 of the present invention. In Embodiment 1, the width (W3) of the thermally sprayed fixed layer 3 was equal to the width (W1) of the first portion 23a. However, the width (W3) of the thermally sprayed fixed layer 3 may be wider than the width (W1) of the first portion 23a.

In particular, when each tooth portion 23 is provided with a plurality of second portions 23b and each thermal sprayed fixed layer 3 is provided so as to be across a part of the plurality of second portions 23b, that is, there is a second portion 23b which is not provided with the thermally sprayed fixing layer 3, it may take the form as shown in FIG. 4. That is, as shown in FIG. 4, the thermally sprayed fixed layer 3 on one of the first and second teeth portions 231, 232 may be formed so as to be inserted into at least one groove 23d formed by the first and second portions 23a, 23b of the other of the first and second teeth portions 231, 232. It is preferable that the position of the second portion 23b of the first tooth portion 231 in the extending direction 23E of the tooth portion 23 from the base portion 20 at least partially overlaps with the position of the second portion 23b of the second tooth portion 232 in the same direction. The thermally sprayed fixed layer 3 may be inserted into the grooves 23d of the tooth portions 23 on both sides, or may be inserted into the groove 23d of the tooth portion 23 on one side. Other structures are the same as those of Embodiment 1.

### Embodiment 3

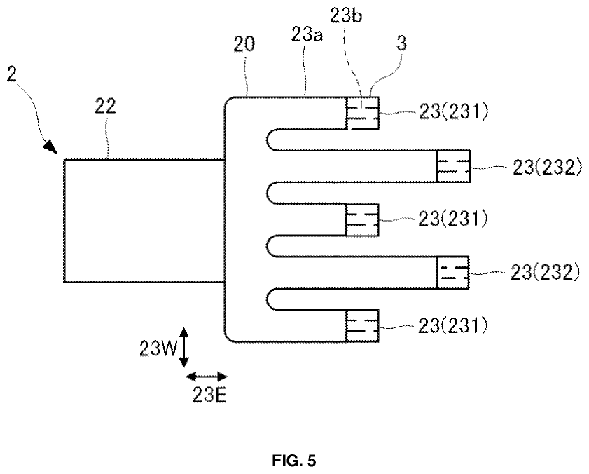

FIG. 5 is a plane view showing a metal electrode 2 and thermally sprayed fixed layers 3 of an electrically heating support according to Embodiment 3 of the present invention. In Embodiment 1, each tooth portion 23 had the plurality of first and second portions 23a, 23b. However, as shown in FIG. 5, each tooth portion 23 may have one first portion 23a and one second portion 23b.

The first portion 23a may extend between the base portion 20 and the second portion 23b on which the thermally sprayed fixed layer 3 is provided. In other words, the other second portion 23b (the second portion 23b on which the thermally sprayed fixed layer 3 is not provided) may not be provided between the second portion 23b on which the thermally sprayed fixed layer 3 is provided and the base portion 20. This allows the amount of current limited by the second portion 23b to be more restrictive. In Embodiment 3, the thermally sprayed fixed layer 3 is provided on the second portion 23b provided at the tip of each tooth portion 23. However, at least one of the first and second portions 23a, 23b may be further provided beyond the second portion 23b on which the thermally sprayed fixed layer 3 is provided.

In Embodiment 1, the thermally sprayed fixed layer 3 was provided with the exposed portions which were not covered with the thermally sprayed fixed layer 3 on both sides. However, as shown in FIG. 5, the thermally sprayed fixed layer 3 can be arranged adjacent to the first portion 23a. In particular, it may be arranged adjacent to the first portion 23a on the side closer to the base portion 20 than the thermally sprayed fixed layer 3. This allows the amount of current limited by the second portion 23b to be more restrictive. Other structures are the same as those of Embodiments 1 and 2.

### Embodiment 4

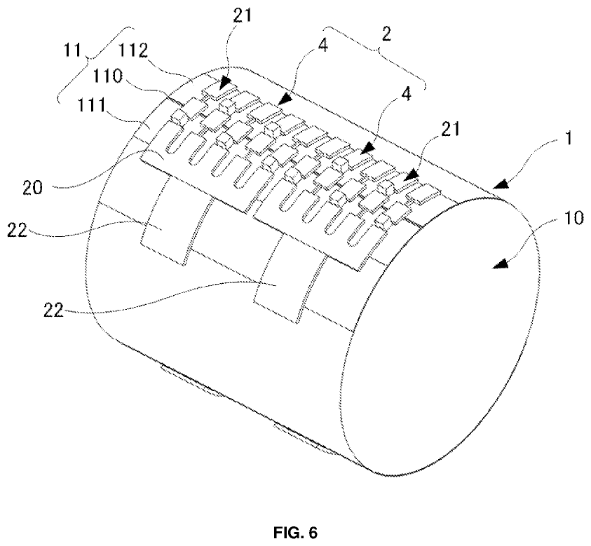

FIG. 6 is a perspective view of an electrically heating support according to Embodiment 4 of the present invention. In Embodiment 1, one connection portion 21 was provided for each of the pair of metal electrodes 2. However, as shown in FIG. 5, a plurality of electrode bodies 4 each having a connection portion 21 may be provided for each of the pair of metal electrodes 2. Each structure of the electrode bodies 4 may be the same as that of the metal electrode 2 as described in Embodiments 1 to 3. That is, each of the electrode bodies 4 has a base portion 20, a connection portion 21, and a drawer portion 22. FIG. 6 shows an embodiment where the plurality of electrode bodies 4 having the same shape are provided on the metal electrode 2. However, the shapes or structures of the plurality of electrode bodies 4 provided on the metal electrodes 2 may be different from each other. Other structures are the same as those of Embodiments 1 to 3.

### DESCRIPTION OF REFERENCE NUMERALS

1: honeycomb structure
10: honeycomb structure portion
100: outer peripheral wall
101: partition wall
101a: cell
11: electrode layer
110: separator
111: first partial electrode layer
112: second partial electrode layer
2: metal electrode
20: base portion
21: connection portion
23: tooth portion
23a: first portion
23b: second portion
23d: groove
231: first tooth portion
232: second tooth portion
3: thermally sprayed fixed layer
4: electrode body

1. An electrically heating support, wherein the electrically heating support comprises:
a honeycomb structure comprising: a honeycomb structure portion having an outer peripheral wall and a partition wall arranged on an inner side of the outer peripheral wall, the partition wall defining a plurality of cells each extending from one end face to other end face to form a flow path; and a pair of electrode layers provided on a surface of the outer peripheral wall;
a pair of metal electrodes for applying voltage to the honeycomb structure; and
a plurality of thermally sprayed fixed layers for fixing the pair of metal electrodes to the honeycomb structure,
wherein each of the pair of metal electrodes comprises: a base portion; and a comb tooth-shaped connection portion having a plurality of teeth portions each extending from the base portion,
wherein each of the tooth portions comprises at least one first portion and at least one second portion narrower than the first portion, and
wherein at least one of the thermally sprayed fixed layers is provided on an outer peripheral surface of the honeycomb structure and the at least one second portion so as to be across the at least one second portion in a width direction of the tooth portions so that the connection portion is fixed to the honeycomb structure.

2. The electrically heating support according to claim 1, wherein the at least one first portion extends from the base portion and the at least one second portion extends from a tip of the at least one first portion.

3. The electrically heating support according to claim 1,
wherein the plurality of tooth portions comprise:
first tooth portions fixed to the honeycomb structure at first positions; and
second tooth portions fixed to the honeycomb structure at second positions which are different from the first positions in an extending direction of the tooth portions from the base portion.

4. The electrically heating support according to claim 3, wherein the first and second teeth portions are alternately arranged in an extending direction of the base portion.

5. The electrically heating support according to claim 3,
wherein each of the tooth portions comprises a plurality of the second portions, and each of the thermally sprayed fixed layers is provided so as to be across a part of the plurality of second portions, and
wherein the thermally sprayed fixed layer on one of the first and second tooth portions is formed to be inserted into at least one groove formed by the other of the first and second portions on the first and second teeth portions.

6. The electrically heating support according to claim 1, wherein each of the tooth portions comprises a plurality of the second portions, and each of the thermally sprayed fixed layers is provided so as to be across at least one of the second portions.

7. The electrically heating support according to claim 1, wherein a ratio (A2/A1) of an area (A2) of each of the second portions covered with each of the thermally sprayed fixed layers to an area (A1) of each of the thermally sprayed fixed layers as viewed along a thickness direction of the thermally sprayed fixed layer and the second portion is more than or equal to 0.1 and less than or equal to 0.5.

8. The electrically heating support according to claim 1, wherein the connection portion has a thickness of less than or equal to 0.05 mm and less than or equal to 0.7 mm.

9. The electrically heating support according to claim 1, wherein each of the pair of metal electrodes comprises a plurality of electrode bodies each having the connection portion.

10. The electrically heating support according to claim 1, wherein a central position of each of the thermally sprayed fixed layers in the extending direction of the tooth portion from the base portion is located at the same position as a central portion of each of the second portions in the extending direction, or located at a position closer to the base portion than the central portion of each of the second portions in the extending direction.

11. The electrically heating support according to claim 1, wherein each of the thermally sprayed fixed layers is arranged adjacent to the at least one first portion.

12. The electrically heating support according to claim 1, wherein a ratio (W2/W1) of a width (W2) of the at least one second portion to a width (W1) of the at least one first portion is more than or equal to 0.3 and less than or equal to 0.8 or less.
